(19) United States
(12) Patent Application Publication
(10) Pub. No.: US 2009/0125684 A1
(43) Pub. Date: May 14, 2009

(54) Timer Device For Monitoring Expiration Of Products

(76) Inventors: Iain Michael Todd, Stockport (GB); Geoffrey Philip Archer, North Skelton (GB)

Correspondence Address: BOYLE FREDRICKSON S.C., 840 North Plankinton Avenue, MILWAUKEE, WI, 53203, US

(21) Appl. No.: 11/575,733

(22) PCT Filed: Aug. 22, 2005
(86) PCT No.: PCT/GB05/03280

§ 371 Date: Mar. 21, 2007

(30) Foreign Application Priority Data
Sep. 22, 2004 (GB) 0421009.2

(51) Int. Cl. G06F 12/00

(52) U.S. Cl. 711/128

(57) ABSTRACT

A timer device adapted to monitor time periods associated with foods and other substances which may have a finite time during which they are suitable e for use, comprising a timer unit (8) capable of monitoring a plurality of time periods, each time period being associated with a tag (1) identifiable by a unique code such as an alphanumeric code. The tags (1) are attachable to a product such as a lid (2) of a food jar, and its identifiable code may be entered on a key pad (12) of the unit (8) such that the period during which the tag has been attached to the jar is monitored on the timer unit (8) and may be read at any time during the preselected period during which the product in the jar is usable. The device assists in ensuring safe use of products and reduces product wastage.

This invention concerns a timer device and particularly such a device adapted to monitor time periods associated with foods and other substances which may have a finite time during which they are suitable for use.

Many materials such as foods and adhesives must be used within a recommended time period after opening or mixing, after which they are no longer suitable for use. Often, such materials do not undergo an obvious physical change as the period expires and this is particularly true with prepacked foods. It is therefore left to the user to remember back to the time which the material was opened, each time they come to use it. This exercise is unreliable and results in useable material being discarded prematurely or, what is worse, unusable material being used in error. With food, this presents a health risk. With adhesives, product liability risk exists should the bond strength be compromised because of extensive storage.

An object of the present invention is to provide a timer device which may be used to monitor a plurality of time periods, for example, when foodstuffs or adhesives have been opened or mixed, and where, at the expiry of such periods such materials should be discarded. Thus, users need not take the trouble to try to remember the periods during which certain products have been opened. The invention is not limited to packaged materials and their usable period from opening, since some materials have a finite useable time from manufacture or from removal from cold storage, even though they remain unopened.

According to the present invention there is provided a timer device capable of monitoring a plurality of time periods, each time period being associated with a tag having a means of identification, the device being capable of being activated in response to such means of identification start a respective time period associated with that tag so the progression of the associated time period can be determined.

The timer device may have a key pad for manual entry of a unique code as a means of identifying a selected one of such tags.

The unique code associated with at least one such tag may be an alpha/numeric code which may be entered on the key pad of the timer device.

The timer device may have a means of retrieving or setting the lengths of the respective time periods associated with the respective tags.

The time periods may be selected as a number of days.

The time periods may be selected as a number of hours.

A current elapsed period of a selected time period may be determined.

A current remaining period of a selected time period may be determined.

Each tag or at least one of such tags may be associated with the timer device such that upon activation or removal of such tag from a base location, the associated unique code is entered automatically and a respective time period is started, and wherein upon deactivation or replacement of the tag to the base location the timing is automatically stopped.

Each tag or at least one of such tags may be removably mounted on the timer device such that upon removal, the associated identification is entered automatically and a respective time period is started, and wherein upon replacement of the tag to the base location the timing is automatically stopped.

At least one such tag may be magnetically mountable upon an object to be timed.

At least one such tag may have a clip for removable attachment to an object to be timed.

At least one such tag may have means enabling adhesive attachment to an object to be timed.

The timer device may include means to display a list of currently activated time periods associated with a plurality of such tags.

The timer device may have means to actuate a visual and/or audible alarm when a respective time period has elapsed.

The alarm means may be operable to be actuated when a proportion of a respective time period has elapsed.

An embodiment of the invention will now be described, by way of example only, with reference to the accompanying drawings in which

FIG. 1 schematically illustrates an activated tag attached to a storage jar lid.

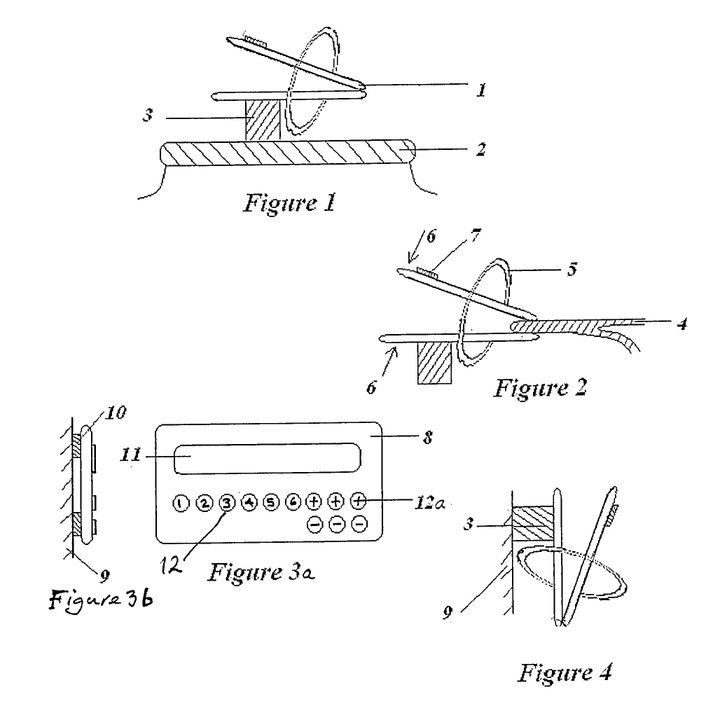

FIG. 2 shows an activated tag attached to the edge of a tray.

FIGS. 3a and 3b show respectively front and side views of a timer unit with a data entry key pad, and attached to upright surface.

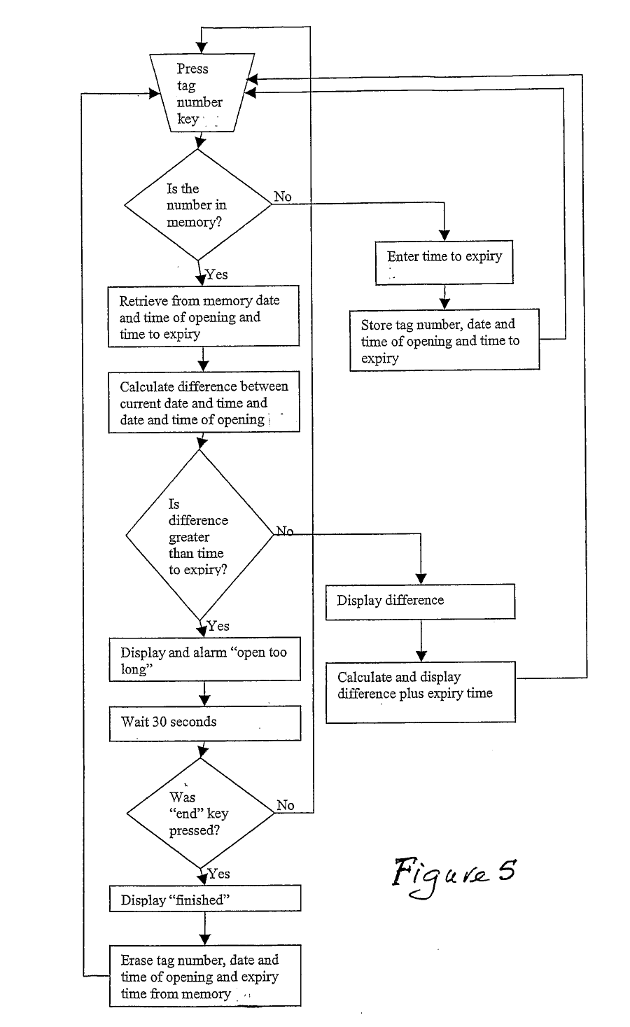

FIG. 4 shows a deactivated tag attached, for storage, to an upright surface and

FIG. 5 is a flow diagram illustrating a mode of operation of the timer device.

Referring in more detail to the drawings, FIG. 1 shows a tag 1 attached to a storage jar lid 2 by means of a magnet 3.

FIG. 2 shows such a tag attached to the edge of a tray by means of a spring clip 5 which is opened by applying force in the direction of arrows 6. Each tag 1 is identified by a number displayed at 7.

FIGS. 3a and 3b shows a timer unit 8 attached to a refrigerator door 9 or the like by means of magnets 10. The unit 8 includes a display panel 11 which, for example, may have a alpha/numeric LCD display visible from the front of the unit. A key pad 12 enables entry of data and switching of the display.

The timer unit internally comprises a microprocessor, read only memory, random access memory, power source and input/output drivers, with programming and associated circuitry to enable functionality as will be described in relation to FIG. 5.

To describe how a timer device made in accordance with the invention may be operated, it will be assumed that a plurality of tags 1 are provided, typically some 8 or 10 in number and that the device is arranged, in its simplest form, for manual selection of the respective time periods associated with the tags.

Assuming there are six tags for use with the timer device, then it shall be possible for each tag to have an identifying number, say 1 to 6, and for each tag, the timer device must be selectable for a certain length of time which may be a number of months, weeks, days or hours.

It is therefore intended that a particular tag may be selected and placed upon the lid 2 of a food jar which has been opened. The user will have determined that the contents of the jar will remain useable for a period of time, say ten days. Therefore the user will select a period of ten days by operating ‘plus’ and ‘minus’ keys on the key pad 12 against that particular tag code. Thus the timer will start timing that 10-day period. The user may, at any time during that period, press the code key for the associated tag and determine the elapsed time and/or the time remaining until the product becomes unusable.

When a number of such tags are in use and a corresponding number of time periods are running, it shall be possible to select a list of such periods on the display so that the user can access that information at any time in order, perhaps, to use up food products most economically. Thus, at the press of a specific key a list of all tag numbers that are in use with their corresponding times of opening, expiry time and time left before expiry, may be displayed. The list is preferably in ascending order of time left before expiry to help the user plan meals to minimise waste of material.

The timer may be operated such that when a predetermined proportion of a selected period has elapsed, or when there is a predetermined proportion thereof remaining, an alarm will sound or a visual warning will be displayed to indicate that that particular food or material with the corresponding tag number must be used within a certain final period such as a day or a number of hours. Again, this will help the user to reduce wastage. The same, or a different, audible or visual alarm may sound or be displayed at the end of the selected period.

All of these options may be made available by appropriate selection of modes provided by the microprocessor and user keys.

The current date or time may also be displayed as an additional convenience.

Preferably, the tags and the timer unit, or at least a facia thereon, may be washable and preferably are dishwasher proof.

Referring now to FIG. 5, in accordance with a typical operating mode of the microprocessor, when a particular tag identifying number is pressed the system checks to see if that number is currently in use and if not displays the instruction to enter a period of time whereupon the tag number is stored together with its date and time of opening and the time to expiry. If the system recognised a tag number as being in use then it will retrieve from the memory the date and time of opening of the product and the time to expiry. It would then calculate the difference between the current date and time, and the date and time of opening. If the difference is not greater than the time to expiry then the system will calculate and display the remaining useable time. However, if the time has elapsed then the display will show that the product has been open too long and will wait for the user to press an “end” key whereupon the display will indicate that the associated tag, associated and the time period associated with it, is “finished” whereupon the tag number and its associated period will be erased from the memory. The time period keys will be provided as + and − keys as shown at 12a for convenience of selection. If required, sufficient keys may be provided for periods of weeks, months, days and hours.

Time elapsed within the system is recorded as

tₛ=t_{c}−tₒ where

tₛ=time since opening
t_{c}=current date and time
tₒ=date and time of opening

The period remaining is calculated as

t₁=tₒ−t_{c}+tₑ where

t₁=time left before expiry
tₒ=date and time of opening
t_{c}=current date and time
tₑ=expiry time

It is not intended to limit the invention to the above examples only. For example, the tag number or identifying code of a particular tag can be entered in a number of different ways such as a radio link between each tag and the timer unit using low data rate, short range RF identification transmitters in the tags and an antenna and receiver in the timer unit.

Alternatively, an electrical or magnetic switching connection between the tags and the timer unit may be provided such that by removing a tag from a predetermined contact position on the housing a switch is actuated to cause entry of the associated tag number and to start the timer. Returning the tag to the housing would again actuate the switch to end the timing process and erase the relative data from the memory.

If required, the tags may be disposable and provided in the form of stickers to be applied to a product container where the stickers bear a number or other identifying code which can be entered on the timer when placed on a product. In this example, the user must take care not to use tags bearing the same code, simultaneously. This can be avoided using combined alpha/numeric codes and/or other identifying features such as colours or shapes.

The tags may be physically associated with the timer device either being mounted on the housing itself, switchable or unswitchable, or by mounting magnetically on, for example, a refrigerator door, next to or adjacent the timer unit.

While the timer device is perhaps most useful in a domestic environment for providing information concerning the remaining period of usefulness of an opened food product, nevertheless it can also be used commercially, or in laboratories, where perishable products such adhesives or other chemical substances are used.

Still further, the device may be used for other tagging purposes such as the time elapsed since an object or person has commenced a particular operation, or departed from a particular location.

1. A timer device capable of monitoring a plurality of time periods, each time period being associated with a tag having a means of identification, the device being capable of being activated in response to such means of identification to start a respective time period associated with that tag, each tag or at least one of such tags being associated with the device such that upon activation or removal of such tag from a base location, an associated unique code is entered whereupon the respective time period may be started, and wherein upon deactivation or replacement of the tag to the base location, the timing may be stopped.

2. A timer device according to claim 17 wherein the unique code associated with at least one such tag is an alpha/numeric code which may be entered on the key pad.

3. A timer device according to claim 1 wherein the length of the respective time periods associated with the respective tags may be selected.

4. A timer device according to claim 3 wherein the length of the time period may be selected as a number of days.

5. A timer device according to claim 3 wherein the length of the respective time periods may be selected as a number of hours.

6. A timer device according to claim 1 wherein the current elapsed period of a selected time period may be determined.

7. A timer device according to claim 1 wherein the current remaining period associated with a particular tag may be determined.

8. A timer device according to claim 1 wherein upon activation or removal of such tag from the base station the associated unique code is entered automatically and the respective time period is started, and wherein upon deactivation or replacement of the tag to the base station, the timing is automatically stopped.

9. A timer device according to claim 1 wherein each tag or at least one of such tags is removably mounted on the device such that removal thereof switches the device to a timing mode for the unique code associated with that tag.

10. A timer device according to claim 1 wherein at least one such tag is magnetically mountable upon an object to be timed.

11. A timer device according to claim 1 wherein at least one such tag has a clip for removable attachment to an object to be timed.

12. A timer device according to claim 1 wherein at least one such tag has means enabling adhesive attachment to an object to be timed.

13. A timer device according to claim 1 including means to display a list of currently activated time periods associated with the plurality of such tags.

14. A timer device according to claim 1 including means to actuate a visual and/or audible alarm when a respective time period has elapsed.

15. A timer device according to claim 1 including means to actuate a visual and/or audible alarm when a proportion of a respective time period has elapsed.

16. A timer device according to claim 1 comprising a timer unit having a microprocessor, read only memory, random access memory, power source and input/output drivers, and the device also includes a plurality of tags each identifiable by a unique code.

17. A timer device according to claim 1 having a key pad for manual entry of a unique code identifying a selected one of such tags.
